(19) United States
(12) Patent Application Publication
(10) Pub. No.: US 2026/0139162 A1
(43) Pub. Date: May 21, 2026

(54) PACKAGING COMPRISING A PACKAGING CONTAINER AS WELL AS A MULTI-LAYER SEALING PART

(71) Applicant: Profol GmbH, Halfing (DE)

(72) Inventor: Josef Altenweger, Rosenheim (DE)

(21) Appl. No.: 19/393,321

(22) Filed: Nov. 18, 2025

(30) Foreign Application Priority Data
Nov. 19, 2024 (DE) 10 2024 133 815.6

(51) Int. Cl. C09J 7/35; B32B 7/027; B32B 7/06; B32B 27/08; B32B 27/32; B65D 65/40; C09J 7/24

(52) U.S. Cl. CPC C09J 7/35; B32B 7/027; B32B 7/06; B32B 27/08; B32B 27/32; B65D 65/40; C09J 7/243; B32B 2250/242; B32B 2307/30; B32B 2307/7376; B32B 2307/748; B32B 2439/40; B32B 2439/70; C09J 2301/304

(57) ABSTRACT

Packaging comprising a packaging container as well as a multi-layer sealing part with at least one carrier layer and one adhesive layer, wherein the adhesive layer of the sealing part adheres to a sealing collar of the packaging container, wherein the carrier layer consists of a first polyolefin-based plastic with a first melting temperature, wherein the adhesive layer consists of a second polyolefin-based elastomer or plastomer with a second melting temperature that is lower than the first melting temperature, and wherein the packaging container consists of a third polyolefin-based plastic with a third melting temperature that is higher than the second melting temperature.

### TECHNICAL FIELD

The present invention relates to a packaging comprising a packaging container as well as a multi-layer sealing part in the form of a film. The film can be applied to a sealing collar of the packaging container with a tool under effect of heat and/or pressure. In a preferred embodiment, a packaging for food is provided which can be opened without leaving any residue and/or is resealable.

### TECHNICAL BACKGROUND

In the field of packaging food, for example, the object is often to seal a target object in the form of a container (for example, a cup, bucket, barrel, etc.). It is known to provide such containers as the target object with a collar-like rim along the opening and to apply a lid made of a film to this rim for sealing. The lid can be made of various materials and can also be applied using various methods. Available methods include, inter alia, bonding, pressing and welding. The selected materials and methods can then each provide certain advantages, but often also suffer from corresponding disadvantages, and therefore the selection of materials and methods for a particular intended use and purpose is often limited.

More recently, additional challenges have also arisen, in particular in the packaging of consumer goods (food, medicaments, cosmetics, consumables, etc.): For example, a certain varietal purity of the packaging as a whole is often necessary for sufficient recyclability. It is often required in this regard that both the container (i.e. the target object in the form of a cup, for example) and the seal (lid) are made of a sufficiently similar or even the same material so that easy recycling is possible upon disposal. Nevertheless, other factors must be taken into account, in particular in the consumer goods sector. Good printability of the materials, compliance with hygiene regulations, and a satisfactory opening experience by the user should be mentioned at this point.

The latter is particularly important for food products since the user, i.e. the consumer, should be given a safe feeling that, firstly, the container was reliably closed before opening and, secondly, that the container does not show any damage after opening and also that the seal was satisfactorily opened. This can relate to a complete removal of the lid within the meaning of opening without leaving any residue and/or a good and sufficiently reliable resealability.

With regard to the compliance with hygiene standards and regulations, it should be mentioned that as a result of filling and sealing of a food packaging, neither the outside of the packaging should be contaminated with the content (i.e. the food) nor the tools and equipment used for packaging should be contaminated with the content or goods to be filled. For example, residues outside on the packaging not only leave an unclean impression but can also spoil and/or contaminate other goods. Contamination of the filling plant (including tool(s), holders, transport mechanisms, etc.) itself is also often undesirable, particularly if the goods to be filled are perishable food.

There is therefore a need for a technology to achieve the above objectives when applying a multi-layer sealing part in the form of a film to a packaging container, particularly in connection with a packaging of goods to be filled. Consideration should thereby also be given to economic efficiency, reliability and an overall satisfactory compliance with all applicable standards. It is therefore a particular object of the present invention to provide a packaging with which one or more of the aforementioned objectives can be achieved.

### SUMMARY

The aforementioned problems and objects are solved by the subject matters of the independent patent claim. Further advantageous embodiments of the present invention are specified in the dependent patent claims.

According to an embodiment of the present invention, a packaging comprising a packaging container as well as a multi-layer sealing part with at least one carrier layer and one adhesive layer is provided, wherein the adhesive layer of the sealing part adheres to a sealing collar of the packaging container, wherein the carrier layer consists of a first polyolefin-based plastic with a first melting temperature, wherein the adhesive layer consists of a second polyolefin-based elastomer or plastomer with a second melting temperature that is lower than the first melting temperature, and wherein the packaging container consists of a third polyolefin-based plastic with a third melting temperature that is higher than the second melting temperature.

### BRIEF DESCRIPTION OF THE FIGURES

The embodiments of the present invention will be explained and illustrated in particular in connection with the following figures. The scope of protection should not be limited to this embodiment, and the figures and the corresponding description thus only serve to illustrate the general inventive concept. The enclosed figures show:

FIG. 1 shows a schematic view of a packaging with a packaging container and a multi-layer sealing part according to an embodiment of the present invention;

FIG. 2 shows a schematic sectional view of a multi-layer sealing part in the form of a film according to an embodiment of the present invention;

FIG. 3 schematically shows a measuring set-up with which opening forces can be measured in a reproducible manner;
and

FIG. 4 shows a schematic sectional view of a multi-layer sealing part in the form of a film according to a further embodiment of the present invention.

### DETAILED DESCRIPTION

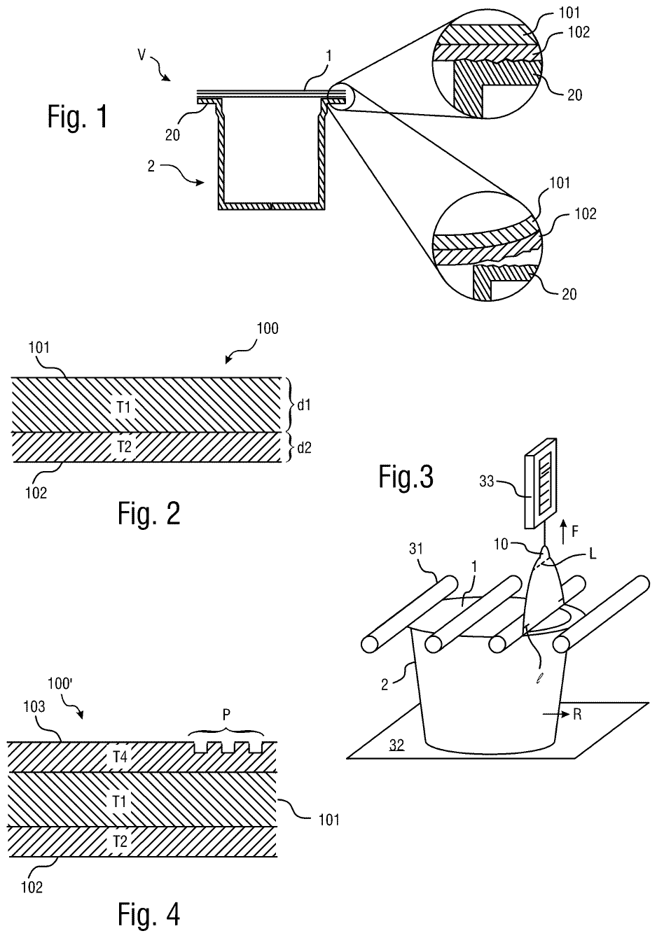

FIG. 1 shows a schematic view of a packaging with a packaging container and a multi-layer sealing part according to an embodiment of the present invention. As shown, a packaging V comprises a packaging container 2 as well as a multi-layer sealing part 1 in the form of a film. The sealing part 1 and, as a semi-finished product, the corresponding film have at least one carrier layer 101 and one adhesive layer 102, the adhesive layer 102 of the sealing part 1 adhering to a sealing collar 20 of the packaging container 2 in a closed or at least partially closed state of the packaging V. The carrier layer 101 consists of a first polyolefin-based plastic with a first melting temperature (T1) and the adhesive layer 102 consists of a second polyolefin-based elastomer or plastomer with a second melting temperature (T2). In this regard, the second melting temperature T2 is lower than the first melting temperature T1. The packaging container 2 furthermore consists of a third polyolefin-based plastic with a third melting temperature (T3) that is higher than the second melting temperature T2.

FIG. 1 also schematically shows further details of an interaction between a molded piece of a film as the sealing part 1 and a target object in the form of the packaging container. Herein, a molded piece made of a film 100 forms a lid as the sealing part 1 for a cup 2 as the packaging container, wherein the film 100 of the lid has been applied to a sealing collar or rim 20 of the cup 2 as an example packaging container. This sealing collar 20 can form an annular sealing collar, in such a sense that this collar in annular shape forms a complete seal of the cup opening and collar-like means a sufficiently broad radial expansion. A conventional annular sealing collar has a diameter from approximately 5 cm to 15 cm and a width of several millimeters. Thus, the shown cup 2 with the lid 1 forms a packaging of a volume-bearing container and a film. The volume-bearing container is closed along a sealing collar, for example along the above-stated rim of the cup, and therein at least in a part with an adhesive bond.

This is shown in particular by the upper enlarged view of the interface between the adhesive layer 102 and the surface of the packaging container 2. The adhesive layer 102 is deformed in such a way that its surface follows the surface structure of the sealing collar 20, so that a sufficiently large, preferably maximal, surface contact is provided. This forms an adhesive bond which, on the one hand, provides a sufficient seal within the meaning of a product packaging but, on the other hand, can also be opened without leaving any residue (see lower enlargement) and/or remains so stable in shape that the packaging can be closed again at least partially.

This advantageous bond—and thus the seal of the packaging—is achieved in particular in that the first melting temperature T1 is higher than the second melting temperature T2, and also the third melting temperature T3 is higher than the second melting temperature T2. The following applies:

$$T 1 > T 2 < T 3 ;$$

Thus, the adhesive layer 102 can be heated to such an extent that it softens or partially melts without either the carrier layer 102 or the sealing collar 20 of the packaging container softening and deforming significantly or even melting. This effectively prevents welding and thus a bond between the sealing part 1 and the packaging container 2, which is difficult to remove and reseal. Furthermore, a simultaneous deformation of the adhesive layer 101 and the surface of the sealing collar is prevented, which would also result in too strong a bond even without welding.

Preferably, a packaging is provided, in which the material systems of the carrier layer, the adhesive layer and the packaging container are based on a polypropylene system. In a preferred embodiment, the layers of the film 100, for example all of the elastomers, plastomers and/or terpolymers of the layers 101 and 102 are polypropylene-based, i.e. the base polymer of the materials of these layers is polypropylene. Alternatively, the material systems of the carrier layer, the adhesive layer and the container can also be based on a polyethylene system. The target object or the volume-bearing container 2 is then also made of a polyolefin-based plastic, which not only promotes the adhesive bond in an advantageous manner if a surface contact between the film and the polyolefin-based plastic of the container is maximal at least in an area of the sealing collar. However, these embodiments also provide a varietal purity of the packaging, which is of essential and advantageous significance, particularly in view of reuse, recycling and sustainability. Preferably, the material systems of the film and the material system of the volume-bearing container are adjusted to each other in such a way that one has only up to 5% by weight of foreign material compared to the other. This ensures particularly favorable varietal purity and the packaging can be disposed of as a whole—or as a container and lid together.

FIG. 2 shows a schematic sectional view of a multi-layer sealing part in the form of a film according to an embodiment of the present invention. Accordingly, a film 100 for forming a packaging is shown, which can be applied to a target object, for example with a tool under the effect of heat, pressure, and/or ultrasound on the target object in the form of a packaging container. In preferred embodiments, the film serves to form a packaging for food, for example together with a cup, a packaging for a dairy product (e.g. yoghurt cup), a dairy substitute product, sausage or meat products, ready meals, pet food and the like. The film 100 is configured for application to a target object and comprises, in this regard, at least one carrier layer 101 and one adhesive layer 102, the carrier layer 101 consisting of a first polyolefin-based plastic with a first melting temperature T1, and the adhesive layer 102 consisting of a second polyolefin-based elastomer or plastomer with a second melting temperature T2. In this regard, the second melting temperature T2 is lower than the first melting temperature T1. Thus, the following applies: T1>T2. Polyolefin-based plastics are, for example, polypropylene (PP) or polyethylene (PE). The adhesive layer 102 can in particular comprise an elastomer and/or a plastomer or consist of one of these materials or a corresponding combination. In addition to the elastomers and/or plastomers, the adhesive layer 102 can additionally comprise a terpolymer to reduce the bonding tendency, i.e. this can prevent bonding and enables adhesion to the target object in order to achieve the above-stated advantages.

The adhesive layer 102 can be melted, partially melted or is at least deformable within limits. The configuration according to the invention enables in particular an application of the film 100 to a target object with the side of the adhesive layer 102. Thus, this adhesive layer 102 is no longer fully accessible, since it is covered by the target object or the sealing collar of the packaging container. However, the solution according to the invention allows sufficient heat input through the—so to speak—upper carrier layer 101, since its melting temperature T1 is higher than the melting temperature T2 of the adhesive layer 102. In a state where the adhesive layer 102 already rests on the target object, it can thus be heated to such an extent that it melts, partially melts or at least becomes deformable, wherein said deformability designates a greater deformability at a temperature under heat input compared to a deformability at room temperature, use temperature or storage temperature.

Said deformability does not necessarily designate a macroscopic deformation visible to the eye, but rather a microscopic adaptation of the film to the roughness of the target object (e.g. to the contact surface of the sealing collar), while forming an adhesion and the corresponding seal. Due to the higher melting temperature T1, the carrier layer 101 can reliably hold the adhesive layer 102 even in a deformed state and thus enables reliable and practical processing in the first place. Since the melting temperature T3 is also higher than the second melting temperature, the microscopic surface of the sealing collar remains sufficiently stable so that a one-sided surface and boundary surface adaptation can take place, forming the advantageous adhesive bond.

Due to the deformability, an adhesive bond with the corresponding surfaces of the target object can be formed in particular in a reproducible manner. This is to be delimited from welding or bonding, which does not necessarily require an optimal surface adaptation of the parts to be bonded, but as a rule forms a connection that is too strong. In particular, the forces required to dissolve an adhesive bond or a weld may be greater than the forces sufficient to dissolve an internal bond in the layer structure of the used packaging films. For this reason, such packaging often “tears” when opened, leaving packaging residue in the form of shreds or threads on the food packaging. This is often perceived as very disadvantageous, since consumers fear contamination of the food with the packaging residues.

According to corresponding embodiments of the present invention, a first removal force for initial removal of the multi-layer sealing part from the sealing collar of the packaging container lies in a range from 10 N to 20 N, and preferably a second removal force for further removal lies in a range from 1 N to 5 N. The initial removal designates the process in which the opening of the multi-layer sealing part is begun, starting from a completely closed state. The initial removal can take until a state in which the packaged goods become accessible for the first time. This first removal force is as a rule greater than other forces to be considered during opening since an opening line can initially be greater than at later points in the opening process.

FIG. 3 schematically shows a measuring set-up with which opening forces can be measured in a reproducible manner. An exemplary measuring device is also archived on the Internet and accessible via
https://web.archive.org/web/20240430080932/https://www.zwickroell.com/filead min/content/Files/SharePoint/user_upload/PI_DE/10_611_Deckel_Abziehvorrichtun g_fuer_peelbare_Verpackungen_PI_DE.pdf

The measuring device comprises a set of rollers 31 under which a sample (i.e. a sealed packaging V according to the invention) can be held down on a slide 32. For example, a force F is exerted vertically upwards on an opening flap 10 of the multi-layer sealing part 1 with a force measuring device 33, so that the removal force can be measured while the packaging is opened, the lid (sealing part) is pulled off upwards and the packaging moves accordingly on the slide 32 (in this case to the right [R]). Initially, the packaging opens along a relatively long opening line, while this is later reduced to relatively small opening lines, which is due to the geometry of the annular sealing collar. The opening lines shown in the figure are drawn as imaginary lines L and I, which correspond to the corresponding lines at the respective opening time. According to the embodiments of the present invention, the removal force during the entire opening process lies in the above-stated ranges and always below the force resulting in a removal of the adhesive layer 102 from the carrier layer 101 or to tearing or rupture of the film 100.

In general, the film according to the invention forms a packaging which can be opened without leaving any residue. Similar considerations apply to resealability, which is often made impossible simply because the packaging parts break when opened. In contrast, a film according to the invention can form a packaging which does not tear or break upon removal (from the target object in the form of a cup, for example) and therefore remains stable in shape. This stability in shape can be essential for the bonding surface to be available again for an adhesive—albeit not as strong—bond if the packaging is supposed to be resealed.

Preferably, the carrier layer 101 has a first layer thickness d1 and the adhesive layer 102 has a second layer thickness d2. The first layer thickness d1 and the second layer thickness d2 are adjusted to each other in such a way that a heat input through the carrier layer 101 is associated with a deformation of the adhesive layer 102 while forming an adhesive bond with at least one partial area of the target object. This advantageous combination of layer thicknesses and melting temperatures in particular enables very reliable processing adjusted to the target object. In this regard, the first layer thickness d1 can lie in a range from 10 μm to 600 μm and the second layer thickness d2 can lie in a range from 5 μm to 30 μm. Alternatively or additionally, a ratio of the first layer thickness d1 to the second layer thickness d2 can also be set accordingly and lie in a range from 1:1 to 20:1, for example. Thus, the carrier layer 101 is preferably thicker than the adhesive layer 102.

In general, a heat input through the carrier layer 101 necessary for the application and the second melting temperature T2 can be set in such a way that the adhesive layer 102 is deformed while forming an increased surface contact with at least one partial area of the sealing collar of the target object. In this regard, the adhesive layer 102 can at least partially melt or start to melt. The temperature can be close to or above the second melting temperature T2. The properties of the carrier layer 101 and adhesive layer 102, in particular the melting temperature T2, thus determine whether there is a heat input within the meaning of a temperature and performance profile over time, through which an adhesive bond with the target object is achieved. In this regard, the surface contact can be increased maximally, so that the contact of the surfaces of the adhesive layer 102 and of the target object is complete, i.e. in particular the shape of the surface of the adhesive layer 102 in the applied state follows the shape of the target object within the sealing area (for example, an annular collar along the rim of a cup).

Preferably, the first melting temperature T1 of the carrier layer 101 lies in a range from 100° C. to 160° C. and the second melting temperature T2 of the adhesive layer 102 lies in a range from 40° C. to 90° C. Furthermore, the third melting temperature T3 of the packaging container or the material of the sealing collar preferably lies in a range from 150° C. to 165° C. In general, the first melting temperature T1 can be higher than the second melting temperature T2 by at least 10°, preferably by at least 20°. Thus, in the material systems at issue, a good deformability of the adhesive layer 102 can be achieved while simultaneously maintaining stability in shape of the carrier layer 101. This applies in particular to the material systems of the adhesive layer 102 based on polypropylene and/or polyethylene.

FIG. 4 shows a schematic sectional view of a multi-layer sealing part in the form of a film according to a further embodiment of the present invention. Accordingly, a film 100′ again comprises the layers 101 and 102 as described above. In this embodiment, the film 100′ comprises an additional layer 103 on the carrier layer 101. Preferably, the additional layer 103 also consists of a polyolefin-based plastic, the formulation or composition of which differs from the layers 101 and 102. Furthermore, the melting temperature T4 of the polyolefin-based plastic of the additional layer 103 can also be higher than at least the second melting temperature T2, so that a heat input for the deformation and formation of adhesion of the adhesive layer 102 is also possible through the carrier layer 101 and the additional layer 103. By providing the additional layer 103, the processability of the film extrusion process and the printability of the film can in particular also be improved. Optionally, the additional layer 103 can have an embossing P.

In general, the plastic films according to the described embodiments can replace the previously used aluminum lids. In the case of a PP cup, this film can then be recycled together with the cup. The adhesive layer can provide a peel layer consisting of a low-heat sealing polyolefin elastomer or plastomer, i.e. which melts at relatively low temperatures. When sealing/closing cups made of polypropylene, for example, it can be particularly advantageous to use a material consisting of a metallocene-catalyzed polypropylene with different proportions of ethylenes. Thus, a particularly advantageous, complete recyclability of PP cup and lid can be provided. A further advantage of using the described layers is that the peel forces (removal forces) can be individually adjusted via the time, temperature and pressure during application, i.e. both relatively loosely sealed packagings and relatively tightly sealed packagings can be provided. For example, a yoghurt cup can be opened easily by a child's hand, whereas pet food, for example, may require more force to open.

A further advantage of the described films can be seen in the low sealing temperature. This means the film can be applied to a target object at relatively low temperatures (compared to conventional technologies). The temperature range can also lie below a range in which printing inks from directly printed lids break up or are destroyed. A further advantage can also be seen in that dimensional deviations of the sealing tool in relation to the cup can be compensated for by the flexible adhesive layer and a uniform peel pull-off force is provided across the sealing surface along a sealing collar during opening.

Although detailed embodiments of the invention have now been described, these should only serve for a better understanding of the invention and its effects. The scope of protection is defined by the following claims and should not be limited by the detailed description.

1. Packaging comprising a packaging container and a multi-layer sealing part with at least one carrier layer and one adhesive layer, wherein the adhesive layer of the sealing part adheres to a sealing collar of the packaging container, wherein the carrier layer consists of a first polyolefin-based plastic with a first melting temperature, wherein the adhesive layer consists of a second polyolefin-based elastomer or plastomer with a second melting temperature that is lower than the first melting temperature, and wherein the packaging container consists of a third polyolefin-based plastic with a third melting temperature that is higher than the second melting temperature.

2. The packaging according to claim 1, wherein the carrier layer has a first layer thickness and the adhesive layer has a second layer thickness, and wherein the first layer thickness and the second layer thickness are adjusted to each other in such a way that the adhesive layer forms an adhesive bond with the sealing collar of the packaging container by heat input through the carrier layer.

3. The packaging according to claim 2, wherein the heat input through the carrier layer and the second melting temperature are set in such a way that the adhesive layer is deformed while forming an increased surface contact with at least one partial area of the sealing collar of the packaging container.

4. The packaging according to claim 1, wherein the first layer thickness lies in a range from 10 μm to 600 μm and the second layer thickness lies in a range from 5 μm to 30 μm and/or a ratio of the first layer thickness to the second layer thickness lies in a range from 1:1 to 20:1.

5. The packaging according to claim 1, wherein the first melting temperature lies in a range from 100° C. to 160° C., the second melting temperature lies in a range from 40° C. to 100° C., and the first melting temperature is higher than the second melting temperature by at least 10°.

6. The packaging according to claim 1, wherein the third melting temperature lies in a range from 150° C. to 165° C., and the third melting temperature is higher than the second melting temperature by at least 10°.

7. The packaging according to claim 1, wherein a first removal force for initial removal of the multi-layer sealing part from the sealing collar of the packaging container lies in a range from 10 N to 20 N.

8. The packaging according to claim 1, wherein a material system of the adhesive layer, the carrier layer and the packaging container is based on polypropylene and/or polyethylene.

9. The packaging according to claim 1, wherein the multi-layer sealing part comprises an additional layer on the carrier layer.

10. The packaging according to claim 1, wherein at least in an area of the sealing collar a surface contact between the multi-layer sealing part and the sealing collar is maximal.

11. The packaging according to claim 5, wherein the first melting temperature is higher than the second melting temperature by at least 20°.

12. The packaging according to claim 6, wherein the third melting temperature is higher than the second melting temperature by at least 20°.

13. The packaging according to claim 7, wherein a second removal force for further removal lies in a range from 1 N to 5 N.
